(19) United States
(12) Patent Application Publication
(10) Pub. No.: US 2003/0167678 A1
(43) Pub. Date: Sep. 11, 2003

(54) System to monitor and control subterranean termites by use of a soil additive and method thereof

(76) Inventors: Seth C. Hunt, Golden, CO (US); Carl McFarland, Cincinnati, OH (US); Lawrence Washburn, Hyden, KY (US)

Correspondence Address: Keith R. Haupt, Wood, Herron & Evans, L.L.P., 2700 Carew Tower, 441 Vine Street, Cincinnati, OH, 45202-2917, US

(21) Appl. No.: 10/366,639

(22) Filed: Feb. 13, 2003

Related U.S. Application Data
(60) Provisional application No. 60/356,866, filed on Feb. 14, 2002.

(51) Int. Cl. A01M 1/20; A01M 5/00; A01M 7/00

(52) U.S. Cl. 43/132.1

(57) ABSTRACT

Monitoring and controlling termite activity is accomplished by use of a soil additive in conjunction with a termite bait station. A material is added to the soil adjacent the bait station to retain moisture in the soil. Retention of moisture in the surrounding soil causes the bait material itself to remain moist for longer periods of time while enhancing the attraction and lure of termites to the bait station for longer periods of time. As such, the use of the material improves the efficacy and accuracy of the bait station.

This claims the benefit of U.S. Provisional Patent Application Serial No. 60/356,866, filed Feb. 14, 2002, and hereby incorporated by reference entirely.

### FIELD OF THE INVENTION

The invention generally relates to a system of monitoring and controlling subterranean termites by the use of a soil additive in conjunction with a termite bait station. The invention further relates to a method to use the system.

### BACKGROUND OF THE INVENTION

It has long been known that termites can enter homes and other man-made building structures and cause serious damage. Moreover, it has been reported that termites, and especially subterranean termites, cause more damage to wooden portions of building structures than any other insect. Thus, preventing such termite damage is critical to avoiding related building repairs and dangerous conditions.

Termites generally infest wood that is wet. Typically, wood may become wet due to such factors including climate, design of building structures, state of repair, proximity of natural water sources, and porosity or type of soil immediately adjacent the wooden building structure infested by termites. The water in contact with the wood structure typically extracts water-soluble compounds from wood. Extraction and dissolution of such compounds into the water attracts and lures termites to the moist wooden structures.

Subterranean termites survive by finding and colonizing wet and moist portions of wooden building structures. If the wooden portions are kept dry, the subterranean termites may not find them. However, keeping the wooden portions dry is not always feasible economically or practically. It is therefore desirable to protect the wooden building structure by providing an alternative food source, attractive to termites, which may be used to contain and control the termites.

Methods to monitor and control the population of termites in soil surrounding buildings containing wooden structures are common. Typically, these methods utilize bait stations placed strategically around the building to be protected. These stations are generally capable of monitoring the local termite population and the rate of termite infestation in the ground around the building. Accurate monitoring of termite population and infestation by each bait station is necessary to allow reliable and effective control of the termites in the surrounding area. However, these bait stations are not without their weaknesses.

Reliability of the bait stations for purposes of monitoring termites has been an ongoing issue. Termites, are known to be random foragers searching for any wooden structure on which to feed. Their search generally leads the termite to moist and wet locations, typically to a wet wooden structure. The presence of an attractive and luring bait, such as a piece of moist wood, in an intervening termite bait station may, however, divert the termite to the station. Unfortunately, the bait stations of the prior art generally become less reliable as the attractiveness of the lure decreases with a decrease in moisture in the bait. Moisture generally dissipates into the surrounding soil or evaporates due to factors including climate conditions, porosity of the surrounding soil, and depth of the bait station. In addition, these factors may render the bait station ineffective, thereby not providing a sufficient lure to deter the termite from the wooden building structure. Thus, in their search for food, the termite may randomly bypass the moisture-depleted bait station and instead, find and infest the moisture laden wooden structure in the neighboring building. Hence, there is a constant need to improve upon the reliability and efficiency of termite bait stations.

### SUMMARY OF THE INVENTION

The present invention addresses these and other problems associated with the prior art by providing a system and a method of monitoring and controlling termite activity by use of a soil additive in conjunction with a termite bait station. More particularly, the invention relates to the use of a material, added to the soil adjacent the bait station, to retain moisture in the soil. Retention of moisture in the surrounding soil causes the bait material itself to remain moist for longer periods of time while enhancing the attraction and lure of termites to the bait station for longer periods of time. As such, the use of the material improves the efficacy and accuracy of the bait station.

The material, or soil additive, is generally any material capable of retaining moisture in soil. For instance, such an additive may be a commercially available material or any additive having a propensity to retain moisture in soil. In addition, it is preferable that the material be inert and non-degradable in soil. For example, an ideal material is one which does not adversely affect other plant and vegetation and is non-detrimental to other life forms in the soil. This material may be typically applied in its commercially available form or formulated into a suitable form for addition to the soil. It may be added directly in granular form, sprayed in a liquid form or applied by any other means conventionally used to allow the material to infiltrate the soil to a depth reasonable to effect a retention of moisture in the soil. One such presently preferred additive material is Isolite®, which is porous, to retain moisture in arid soil conditions, and is also completely inert, and does not degrade.

In addition, the soil additive may be applied to a plurality of bait stations strategically placed in the ground surrounding the wooden building structure to be protected. As moisture is important to randomly foraging termites, retention of moisture around a multitude of bait stations will generally improve and prolong the ability of each bait station to divert the termite away from the building thereby improving upon the efficacy and reliability of the system to monitor and control termites around the entire building. Such an improvement will generally provide greater success in protecting the building thus realizing a cost savings for the user. The soil additive, such as Isolite®, may also be used as an inert carrier for fungi, micro-organisms, insecticides, termiticides, pesticides or other materials having similar properties.

The present invention also provides a method to use the system. This method generally comprises the steps of burying the termite bait station into the ground, equipping the bait station with bait, adding the material to the soil adjacent the bait station, and monitoring the termites in the surrounding soil. Optionally, the soil additive may be added to the soil before burying the bait station.

These and other advantages and features, which characterize the invention, are set forth in the claims annexed hereto and forming a further part hereof. However, for a better understanding of the invention, and of the advantages and objectives attained through its use, reference should be made to the drawings and to the accompanying descriptive matter in which there is described exemplary embodiments of the invention.

### BRIEF DESCRIPTION OF THE DRAWINGS

The objectives and features of the invention will become more readily apparent from the following detailed description taken in conjunction with the accompanying drawings in which:

FIG. 1 is a cross-sectional side view of one embodiment of a subterranean termite monitoring system consistent with aspects of the invention; and

FIG. 2 is an overhead plan view of a termite monitoring system consistent with one embodiment of the invention including a plurality of individual monitoring systems depicted in FIG. 1.

### DETAILED DESCRIPTION OF THE PREFERRED EMBODIMENTS AND DRAWINGS

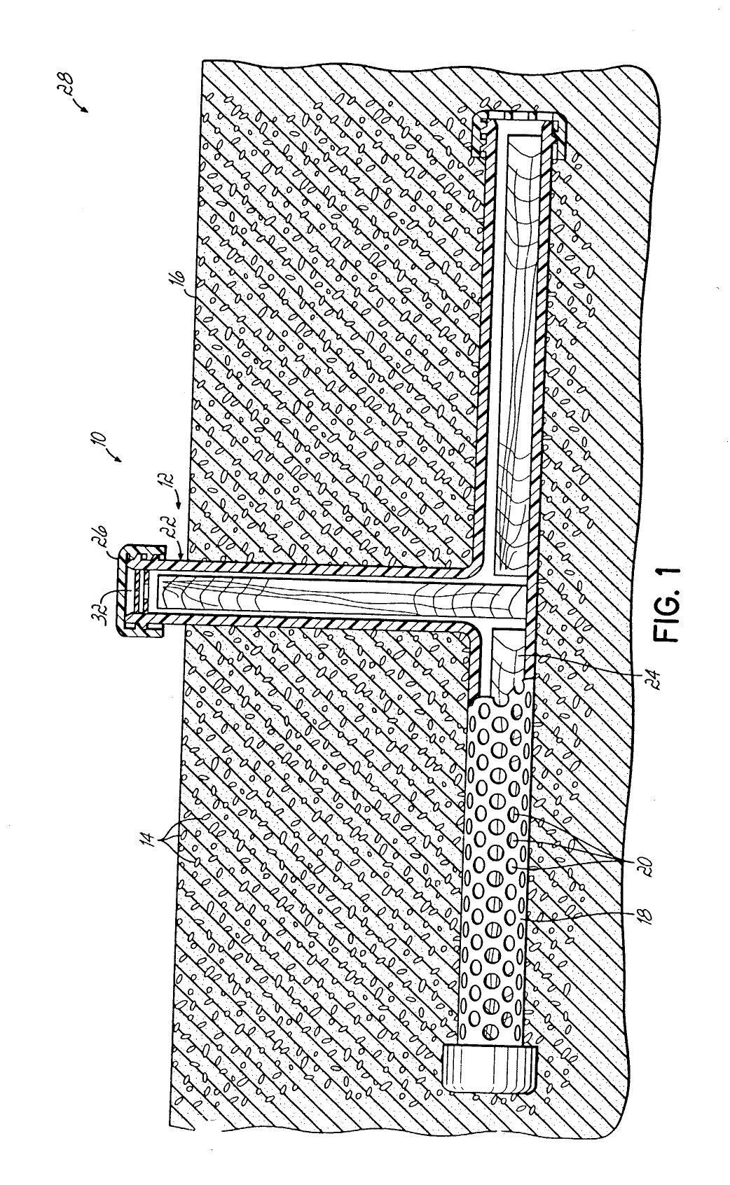

The present invention, as depicted in the drawings, is a termite monitoring system and method of use thereof, to monitor and control the activity of termites. The system 28, as shown in FIG. 1, includes a bait station 10 and a material 14 added to the soil 16 adjacent the bait station. The material 14 in the soil 16 adjacent to the bait station 10 generally improves the ability of the bait station 10 to function by effecting a retention of moisture in the soil 16 surrounding the bait station 10. The term “material” as used herein, in used to refer to any soil additive generally capable of causing a retention of moisture or water vapor in soil. The term “retention”, as used herein, refers to any means to cause water vapor to remain in the soil. Generally, for the purposes of the present invention, any reagent capable of causing a retention of moisture in soil may be used. For instance, the material 14 may be a soil additive which is partially or fully soluble in water or a material which naturally absorbs moisture, such as a desiccant. It is also advantageous if the material 14 counteracts the dissipation and evaporation effects of various factors including, but not limited to, environmental factors such as wind and sunlight, soil porosity, and drainage. It is preferable however, that material 14, while retaining moisture in the soil, is inert. For instance, material 14 should not adversely react with the soil 16 or adversely affect plant vegetation and life forms in the soil 16. In addition, it is preferable that the material 14 not degrade at all or degrade slowly in the soil 16. Slow degradation provides for longer lasting effects, thus providing greater moisture retention in the soil 16 over time. Furthermore, the material 14 may also act as a carrier for, but not limited to, fungi, microorganisms, insecticides, termiticides, and pesticides, conventionally used to deter insects, termites and pests. Conventional reagents may be used as the material 14 in the present invention. For example, one suitable material is the chemical reagent, commercially known as Isolite®. Isolite® is a porous material generally known to not degrade in soil while causing a retention of moisture therein. Isolite®) is commercially available from Foremost Solutions of Denver, Colo., and is described in U.S. Pat. Nos. 5,733,067; 5,626,437; and 5,570,973, each hereby incorporated by reference in its entirety.

The material 14 may be added to the soil 16 adjacent the bait station 10 in any conventional form and by any suitable means. The material 14 may be applied in a commercially available form or it may be formulated. Conventional forms include liquids, formed by mixing or dissolving the material in water or with an appropriate liquid fluid base from which it may be added to the surrounding soil 16. The material 14 may also be added in the form of a granule (FIG. 1) which may dissolve in water or slowly break down releasing components into the soil 16 to effect a retention of moisture.

The material 14 is preferably evenly dispersed by any suitable means to the soil 16. Conventional means are suitable. For instance, the material 14 may be spread with a spreader, sprayed with a sprayer, poured manually or automatically, or applied by any other safe and convenient means. It will be appreciated by one skilled in the art, however, that depending upon the particular material used, concentration and method of application, amounts of the material which cause detrimental effects to the surrounding soil 16, plant vegetation, and/or life forms therein, is excessive and as such, generally undesirable.

The material 14 is generally added to the soil 16 adjacent the bait station 10. The term “adjacent” as used herein, refers to the soil surrounding the bait station 10. The particular radius around the bait station 10 at which the material 14 is applied or the particular concentration at any given point adjacent the bait station 10 is determined by the user depending upon factors including, but not limited to, the level of termite infestation, nature and concentration of the material 14, method of application, the rate of water dissipation, amount of water in the soil 16, and the desired level of termite regulation, in the particular plot of land. Applying the material 14 immediately adjacent the bait station 10, however, may generally provide the best results. The efficiency and efficacy of the bait station 10 may be improved if the material 14 is added to the soil 16 circumferentially surrounding the bait station 10 starting at points closest the bait station 10 and working outwards. For example, the material may be applied from immediately adjacent the bait station up to a radius of 3 to 5 feet. In addition, the material may also be added at radii greater than 5 feet if so desired.

The retention of moisture in the soil 16 adjacent the bait station 10 generally improves the performance of the bait station 10. The level of moisture retention affects the bait station 10 performance. Increased moisture and prolonged moisture in the adjacent soil 16 generally improves the monitoring ability of the bait station 10. Factors, such as soil porosity, climate conditions including wind and sunlight, and soil gradient, affect moisture retention in the soil. Negative effects are generally evaporation and dissipation of the moisture. Therefore, a stronger moisture retaining material 14 is typically preferred. For example, materials 14 such as commercially available Isolite®, known to retain moisture in soil, may be applied at the time of burying the bait station 10 or any time thereafter, but before monitoring begins, to effectively improve the efficacy of the individual bait station 10.

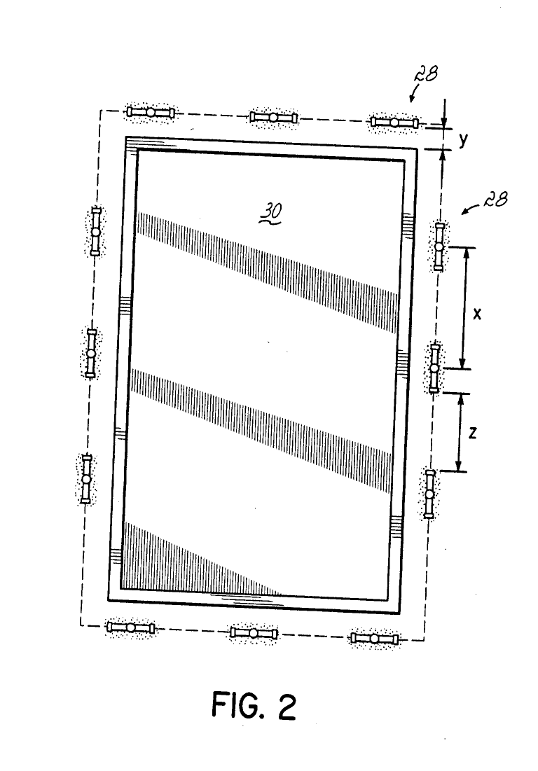

The system 28 of the present invention, as shown in FIG. 2, also comprises a number of individual bait stations 10 as shown in more detail in FIG. 1. As depicted in FIG. 1, one embodiment of the bait station 10 comprises a permeable container 22 configured to hold bait material 24. The permeable container 22 further includes a plurality of apertures 20 allowing the termites access to the bait 24. A portion 12 of the container 22 is reserved to monitor trapped permeated methane gas emitted by the termites upon digestion of the bait 24. The level of termite infestation and activity at the bait station 10 may be derived from the methane levels monitored. This monitoring portion 12 includes a portion above ground which allows access to the user to detect and measure the levels of the methane gas by use of a probe or a sensor. The bait station 10 further comprises a closure 26 adapted to seal the access port 32 when methane levels are not being measured while inhibiting the escape of gases. However, the present invention is not limited to the use of the bait station 10 described above. Any termite bait station capable of regulating termites and monitoring their activity may be used in the present invention. For example, a bait disclosed in pending U.S. application Ser. No. 09/604,369, entitled “Subterranean Termite Monitor and Method”, herein incorporated by reference, may be suitable for the present invention.

The present invention also encompasses a method for monitoring the subterranean termites. The method generally includes the steps of burying a termite bait station 10 in the ground and adding a material 14 to the soil 16 adjacent the bait station 10. This material 14, as described earlier, is a material capable of causing retention of moisture or water vapor in soil. “Burying” the termite bait station 10 involves a number of independent steps resulting in generally placing the bait station 10 in a condition to function. These steps include placing bait material 24 within a permanent container 22 of the bait station 10, burying the permeable container 22 of the bait station 10 into the soil 16 at a desired depth, and leaving exposed an access port 32 in gaseous communication with the permeable container 22. The method also allows for closing the access port 32 with a closure 26, thus inhibiting the escape of methane gasses contained in the container 22 through the access, and opening the access port 32 at the completion of the monitoring interval. The access ports 32 are generally open, thereby inserting a methane sensor or detector to detect the level of methane generated by the consuming termites, thus allowing monitor of the presence of termites at the bait station.

Complete protection of a building may be accomplished by strategically placing a plurality of termite monitoring systems around the building. This is shown in FIG. 2. Generally, the bait stations systems 28 are aligned and placed to maximize protection of the building 30. For instance, individual bait systems 28, as described above, may be placed in the ground at intervals (X) along a perimeter (Y) from a foundation of the building structure 30 in order to monitor and protect the building 30 from infestation by termites. It is preferable to place individual bait station systems 28 equidistant from one another and from the building 30. This would minimize the chances of leaving open, a random path, by which the termites may reach the building 30, without first being attracted to and lured to the bait station system 28.

The system and method of the present invention may effectively be used to regulate termites and prevent termite damage to associated wooden structures. Retention of moisture in the soil surrounding the bait station generally improves the ability and efficacy of the station to the control and monitor termites. The basis for improvement, however, may also be applied to the monitor and regulation of other pests. For instance, the present invention may also be used to control fungi, insects, and other pests via the use of a ‘carrier’ material carrying the desired pesticide.

The application and use may be appreciated by one skilled in the art to not be limited to the embodiments enclosed and other modifications will be apparent to one of ordinary skill in the art. For example, the terms “soil”, “ground”, “dirt”, “earth” and the like as used herein mean any area, material or substratum surrounding a building structure. Therefore, the invention lies in the claims hereinafter appended.

From the above disclosure of the general principles of the present invention and the preceding detailed description of at least one preferred embodiment, those skilled in the art will readily comprehend the various modifications to which this invention is susceptible. Therefore, we desire to be limited only by the scope of the following claims and equivalents thereof.

We claim:

1. A system for detecting and monitoring the presence of termites, the system comprising:
a subterranean bait station capable of being buried in soil and attracting termites; and
a material capable of being added to soil and causing a retention of moisture in the soil, said material being adjacent the bait station.

2. A system for in ground monitoring of subterranean termites comprising:
a bait station, said bait station comprises:
a permeable container configured to hold a bait material, the permeable container including a plurality of apertures for access to the bait material by said termites when the permeable container is buried;
a container monitoring portion in gaseous communication with the permeable container, the container monitoring portion including an access port positioned above ground when the permeable container is buried, the access port configured for insertion of a methane detector;
a closure adapted to selectively seal the access port and inhibit the escape of gases contained in the container through the access port, wherein the permeable container, container monitoring portion, and closure form a methane gas containing vessel when the permeable container is buried, the methane gas generated by the termite consumption of the bait material to be detected by said methane detector and thereby monitor the presence of termites in the bait station; and
a material capable of being buried proximate the bait station and causing a retention of moisture in soil.

3. A method of monitoring subterranean termites comprising the steps of:
burying a termite bait station in the ground, the bait station capable of trapping methane gas emitted by termites;
adding a material to the soil adjacent the bait station wherein said material is capable of causing a retention of moisture in soil; and
detecting the trapped methane gas to monitor the presence of termites.

4. A method of monitoring subterranean termites with a bait station, the method comprising the steps of:
placing bait material within a permeable container of the bait station;
burying the permeable container of the bait station, leaving exposed an access port of the bait station, the access port in gaseous communication with the permeable container;
adding a material to the soil adjacent the bait station, said material capable of causing a retention of moisture in the soil;
closing the access port in the exposed portion of the container monitoring portion to inhibit the escape of gases contained in the container through the access port;
opening the access port at the completion of a monitoring interval; and
inserting a methane detector into the access port to detect methane gas generated by termite consumption of the bait material and thereby monitor the presence of termites in the bait station.

5. The method of claim 4 wherein the material is Isolite®.

6. The method according to claim 4 further comprising the steps of:
using the material as a carrier for at least one of fungi, micro-organisms, insecticides, termiticides, and pesticides.

7. The method of claim 6 wherein the material is Isolite®.
